(19) United States
(12) Patent Application Publication
(10) Pub. No.: US 2009/0234482 A1
(43) Pub. Date: Sep. 17, 2009

(54) System, program and method for calculating equipment load factor

(75) Inventor: Shigeaki Ide, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/320,983

(22) Filed: Feb. 10, 2009

(30) Foreign Application Priority Data
Mar. 13, 2008 (JP) 2008-063819

(51) Int. Cl. G06F 19/00; G06F 7/06; G06F 17/11; G06F 17/30

(52) U.S. Cl. 700/100; 707/3; 703/2; 707/E17.044; 707/E17.014

(57) ABSTRACT

When inputted with a loading plan table file including item names to be loaded into a process line and the number of item names to be loaded, an equipment loop is executed for each equipment. The equipment loop includes an item name loop and a machine-type loop. In the item name loop, a condition group representing a combination of machine types is acquired for each process. In the machine-type loop, distribution factor data for each machine type is acquired for each condition group, and data of a required number of pieces to be processed by process and machine type, the data to be assigned to each machine type on the basis of the distribution factor data. Based on this data of the number of pieces to be processed by process and machine type, machine-type load factor data for each machine type is determined for each equipment.

### BACKGROUND OF THE INVENTION

1. Field of the Invention

The present invention relates to a system, a program, and a method for calculating an equipment load factor.

2. Description of Related Art

In a semiconductor device production plant, based on a required condition, a loading plan for each of multiple semiconductor products is drawn up as to when and how many products will be loaded. In order to determine whether or not products in this loading plan can be loaded or whether or not equipment needs to be enhanced, it is necessary to calculate an equipment load factor for each semiconductor production equipment.

Japanese Patent Application Publication No. 2005-301653 (see Patent Document 1) describes an invention of a manufacturing process control method. In this manufacturing process control method, manufacturing processing is performed by sequentially selecting multiple manufacturing devices each capable of handling one or more processes. The first processing calculates processing time required to process one lot for each process that can be processed with a manufacturing device. The second processing calculates the number of processes that can be processed with each manufacturing device, and the number of devices that can be used in each process. The third processing calculates a priority order for every combination of a manufacturing device and a process based on the processing time, the number of processes that can be processed, and the number of devices that can be used. Based on the number of lots scheduled to be processed by each process in a specified period, the fourth processing assigns one of the lots scheduled to be processed to a manufacturing device that has the highest priority in the most updated order of priority. The fifth processing calculates a device load of the manufacturing device to which the lot to be processed is assigned in the fourth processing. The sixth processing updates the order of priority calculated in the third processing according to the device load calculated in the fifth processing. When all the lots to be processed are assigned to the corresponding manufacturing devices, the seventh processing determines the number of lots to be processed by each process with each manufacturing device. The eighth process directs execution of a process to process an existing lot that can be processed by successively selecting a manufacturing device that has a smallest accomplishment rate, which is a ratio of the number of processed lots to the number of lots scheduled to be processed by the process with the manufacturing device.

The invention described in this Patent Document 1 is a technique related to a manufacturing process control method, such as dispatching, aimed to assign all the lots scheduled to be processed within a certain period of time by sequentially and individually assigning them to equipment starting from that with a highest priority order, and by repeating this step. First, a priority orders with respect to manufacturing equipment and manufacturing process are calculated by the following expression: processing time×number of processable processes×number of available devices. Then, the lots scheduled to be processed are assigned, provided that a smaller numeric value represents a higher priority order. Every time a lot is assigned, the priority order is updated by calculating the expression where processing time×number of processable processes×number of available devices×{((device load)×10) k+1}. Then, by repeating this process, the lots scheduled to be processed within the certain period of time are respectively to be assigned to the manufacturing devices.

[Patent Document 1] Japanese Patent Application Publication No. 2005-301653

### SUMMARY

The invention of Patent Document 1 can equalize the load on equipments each of which processes more than one process. In this equipment load equalization, every time a lot is assigned, re-calculation (an updated value) of the priority orders with respect to the manufacturing equipment and the manufacturing process are updated by calculating an expression including an equipment load. Then, this process is repeated. Thereafter, in this scheme, lots planned to be processed within a certain period of time are assigned to respective manufacturing devices. In other words, processing of steps S4 to S7 in a manufacturing plan control flow chart shown on the left side of FIG. 1 in Patent Document 1 needs to be repeated for the number of times obtained by an expression where number of lots×number of processes.

For example, when an average lot size is 20 devices/lot, in a semiconductor device production plant capable of processing 60,000 pieces/month, the number of pieces to be assigned in a one-month loading plan will be 60,000/20=3,000 lots. Supposing that the average number of processes processed by each equipment is 10 processes and the number of equipment is about 1000, the processing of all the lots to be assigned in one month requires repetitions of the above steps S4 to S7 for 3,000×10×1,000=30,000,000 times, according to the scheme of Patent Document 1.

When forming an actual loading plan, a loading plan is reviewed while considering an equipment load factor of each equipment according to an initial loading MIX (a plan table in which various products and item names are mixed, and which will be referred to as a loading plan table in the specification and drawings.), depending on requirement conditions. The loading plan is finalized by repeating this review a few times. Moreover, since the loading plan table should be modified every time the requirement condition changes even after loading is started. Therefore, a capacity verification (determining whether or not loading is possible by calculating an equipment load factor) needs to be performed several times so as to determine the one-month loading plan. Hence, calculation of the equipment load factor of each equipment needs to be simple and performed in a short period of time.

However, if the scheme of Patent Document 1 is applied to the calculation of the equipment load factor in the semiconductor device production plan as described above, then the processing including assignment of one lot, the calculation of the equipment load, and the calculation of the priority order, needs to be repeated about 30 million times. It is thus readily presumed that the invention of Patent Document 1 requires long tallying time for the re-calculation at the time of changing a loading plan. It is problematic since the invention of Patent Document 1 is not practical.

In semiconductor device production plants, attempts are always being made for reducing loss time in order to achieve the maximum production capacity with the minimum facility investment. Thus, to accurately calculate subsequent equipment capacity, it is necessary to calculate an equipment load factor concerning loss time reduction effect in each equipment at the time of processing productions. However, the calculation of the equipment load factor in Patent Document 1 does not consider a reducing effect of each loss time that is achieved by dividing loss time or process time into eight segments. For this reason, the equipment load factor becomes higher than actual one if loss time can be reduced. This may cause a problem leading to false judgment of whether or not to perform loading according to a given loading plan, or false judgment regarding with an investment of equipment that is in fact unnecessary to be invested.

In semiconductor device production plants, when the number of products to be manufactured is plentiful, a loading plan is formed for each piece under assumption that bottleneck equipment operates at its full capacity. Thus, a small percentage difference in the equipment load factor may lead to a misjudgment of whether or not loading should be performed. Hence, as far as all of constraint conditions are met, the equipment load factors needs to be equalized as much as possible. In contrast, in Patent Document 1, since products are assigned by a lot, there is a problem that a difference in the equipment load factors occurs between equipment types when assignment is completed for all the lots scheduled to be processed within a certain period of time. For example, in Table 7 of Patent Document 1, after all the lots scheduled to be processed are assigned, 4 lots are assigned to a device 3 whereas 16 lots are assigned to a device 2, meaning that there is a 12-lot difference between equipment.

An equipment load factor calculating system (10) according to a first aspect of the present invention includes a database unit (11) and an equipment loop unit (12). The database unit (11) includes an item name database (DB 1) to be searched for, by an item name, a process procedure of the item name. In addition, it includes a process procedure database (DB2) to be searched for, by a process procedure, a process contained in a process procedure, and to be searched for, by a process, equipment to which a process is assigned and a condition to be given to the equipment. It also includes an equipment database (DB3) to be searched for, by equipment and a number machine included in the equipment, a machine type of the number machine; a condition database (DB4) to be searched for, by an item name, equipment to which an a piece corresponding to the item name is loaded, and a condition given to the equipment, a number machine table formed of a combination of number machines operable under the condition. It also includes a condition group database (DB5) to be searched for, by a combination of equipment and machine types included in the equipment, a condition group representing a combination of machine types.

The equipment loop unit (12) includes an item name loop unit (13) configured to: extract, for certain equipment, a process to be assigned to the equipment and a condition of the process by referring to the item name database (DB1) and the process procedure database (DB2); acquire a number machine table for each extracted process, by referring to the condition database (DB4), and acquire, from the number machine table, a condition group for the each extracted process, by referring to the equipment database (DB3) and the condition group database (DB5). It also includes a machine type loop unit (14) configured to: acquire, for each of condition groups, distribution factor data for each of machine types contained in the corresponding condition group; obtain, for each process, data of a required number of pieces to be processed by process and machine type, based on the distribution factor data, the data being to be assigned to each machine type; tally, for each machine type, the data of the number of pieces to be processed; and acquire machine-type load factor data for each machine type.

Since this equipment load factor calculating system can output machine-type load factor data for each equipment when given certain distribution factor data, searching an optimal distribution ratio that will equalize the by-machine type load factor if an appropriate optimization algorithm is applied becomes possible.

According to the present invention, the number of pieces needed to be processed can be calculated for each process and therefore equipment load factors among machine types can be equalized with a very high precision for each equipment.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a view explaining construction of an equipment load factor calculating system;

FIG. 2 is a block explanation drawing of the equipment load factor calculating system;

FIG. 3 is a view showing a specific example of structure of an item name database;

FIG. 4 is a view showing a specific example of structure of a process procedure database;

FIG. 5 is a view showing a specific example of structure of an equipment database;

FIG. 6 is a view showing a specific example of structure of a condition database;

FIG. 7 is a view showing a specific example of structure of a condition group database;

FIG. 8 is a view showing a specific example of structure of an OEE database;

FIG. 9 is an explanation diagram of a process procedure;

FIG. 10 is an explanation diagram of a process;

FIG. 11 is a view explaining a relationship of a condition, a number machine, and a machine type;

FIG. 12 is an explanation diagram of a condition group;

FIG. 13 is a flow chart of an equipment load factor calculating program to be executed by an equipment load factor calculating system;

FIG. 14 is a flow chart of an equipment loop;

FIG. 15 is a flow chart of a condition group subroutine;

FIG. 16 is a flow chart of a machine type loop;

FIG. 17 is a view showing a specific example of a loading plan table file;

FIG. 18 is a view showing a specific example of a condition group matrix table spreadsheet;

FIG. 19 is a view showing a specific example of a by-machine type distribution factor table spreadsheet;

FIG. 20 is a view showing a specific example of a distribution factor spreadsheet for each machine type and condition group;

FIG. 21 is a view showing a specific example of a required sheet number table spreadsheet for each item name and condition;

FIG. 22A is a first view showing a specific example of an OEE loss and process time listing table spreadsheet for each item name and condition;

FIG. 22B is a-second view showing a specific example of an OEE loss and process time listing table spreadsheet for each item name and condition;

FIG. 23A is a first view showing a specific example of a by-machine type capacity tallying table spreadsheet;

FIG. 23B is a second view showing a specific example of a by-machine type capacity tallying table spreadsheet;

FIG. 23C is a third view showing a specific example of a by-machine type capacity tallying table spreadsheet;

FIG. 24 is a view showing a specific example of a machine-type load factor table spreadsheet;

FIG. 25 is a graph showing a relationship among the number of combinations of item names, conditions and the solver converging time;

FIG. 26 is a view showing a specific example of an improvement plan table file;

FIG. 27 is a graph showing a transition in which changeover is improved; and

FIG. 28 is a graph showing a transition in which failure loss is improved.

### DETAILED DESCRIPTION OF THE EXEMPLARY EMBODIMENTS

In this exemplary embodiment, when an equipment load factor is calculated, loss time is considered to include not only downtime such as a failure or routine inspection of equipment, but also time where no added value is given to pieces, such as wafer conveying time or preparation time during processing of process. Here, with time classified into loss time divided into eight loss segments shown below and process time (time during which products are actually processed and given an added value), the loss time and the process time for each process are tallied. With this, when a product is processed, a highly-accurate calculation of an equipment load factor that concerns an effect of reducing loss time for each equipment, is performed. In addition, for any equipment where more than one type can process a same process, the machine-type load factors between these types are equalized as much as possible, provided that various constraint conditions such as the number of processable number machines or the number of chambers for each type are met. In this way, the precision of the calculation of the equipment load factor is enhanced.

The present exemplary embodiment is provided with an equipment load equalizing function that calculates, upon satisfaction of the various constraint conditions, an optimum distribution factor for equalizing the machine-type load factor between the machine types as much as possible. The optimal distribution factor is calculated by using a tallying program that combines a solver (nonlinear optimization analysis program) and mathematical expressions of spreadsheet software. With this, a highly-accurate load distribution optimization is performed in a short period of time.

The optimization used herein means equalization of the machine-type load factor between machine types as much as possible after the various constraints conditions are satisfied. For example, supposing that there are three machine types, namely machine type A, machine type B, and machine type C capable of processing a same process, an optimum solution will be a distribution factor (an assignment ratio representing the number of pieces to be assigned to the machine type A, the machine type B, and the machine type C) making target value=MAX {machine-type load factor of machine type A, load factor of machine type B, machine-type load factor of machine type C}−MIN{load factor of machine type A, machine-type load factor of machine type B, machine-type load factor of machine type C} closest to 0. Although it is ideal for the target value to be 0, there are some cases in which the value is not equal or close to 0, depending on the constraint conditions (a case where the number of pieces that can only be processed by one machine type is extremely large, for example).

In this exemplary embodiment, based on the definition of OEE (Overall Equipment Efficiency), time is classified into the following 8 loss segments and process time, and loss time in each loss segment and the process time are calculated for each process. Thereby, a machine-type load factor is calculated for each machine type.
[1] Planning maintenance loss . . . A period of time during which processing of products is stopped due to a regular inspection or planning maintenance.
[2] Failure loss . . . A period of time during which processing of products is stopped due to a failure of the equipment and maintenance work for improvement and modification of the equipment.
[3] Changeover . . . A period of time during which a device cannot process the products since wafers are conveyed.
[4] Setup . . . An operation to be done prior to an execution of a value-adding operation.
[5] Test time . . . A period of time during which a process check, such as monitoring of dust inclusion, film thickness, etc. other than processing of products, is conducted.
[6] Idle time . . . A period of time during which a wafer can be processed and a machine type is in an unloaded condition.
[7] Speed loss . . . Down loss of device use efficiency per wafer.
[8] Rework loss . . . A period of time during which an operation related with a rework product is performed.

Hereinbelow, a fixed OEE loss is a loss such as planning maintenance loss or failure loss (also referred to as regular maintenance loss in the drawings) that is independent of the number of pieces to be processed and that constantly occurs. On the other hand, a fluctuating OEE loss is a loss such as changeover that varies in response to an increase and decrease in the number of pieces to be processed. In the present exemplary embodiment, for simplicity of the description, an equipment load factor is calculated on the assumption that the equipment operates at its full capacity and the idle time is 0. In addition, it is assumed that no speed loss or rework loss occurs.

OEE stands for Overall Equipment Efficiency. A percentage of time during which the equipment is used to manufacture products is increased by reducing, from the equipment operating time, the loss time such as an equipment failure time, maintenance time, wafer conveying time, preparation time for a value-adding operation, and time spent for NPW (Non Product Wafer) processing.

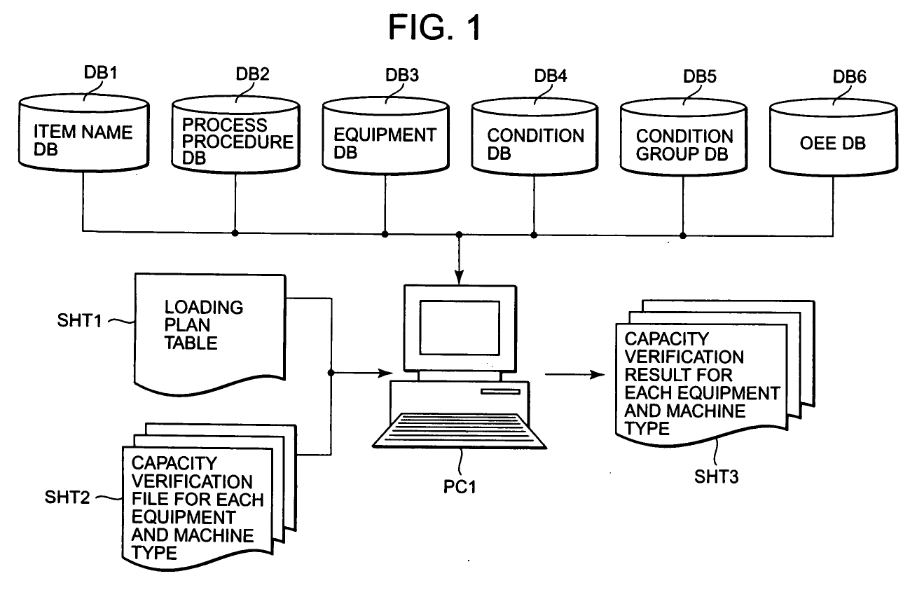

FIG. 1 shows a view explaining a structure of an equipment load factor calculating system. In FIG. 1, an equipment load factor calculating system to be described in this exemplary embodiment is constructed in a personal computer PC1. The personal computer PC1 has an item name database DB1, a process procedure database DB2, an equipment database DB3, a condition database DB4, a condition group database DB5, and an OEE database DB6. The personal computer PC1 reads a loading plan table file SHT1, and a capacity verification file SHT2 prepared for each equipment. The each capacity verification file SHT2 includes a tallying program of each machine type in addition to data. The tallying program refers to the loading plan table file SHT1. When the personal computer PC1 executes this tallying program, capacity verification result of each machine type is outputted. The capacity verification result for each machine type is listed in a capacity verification result file SHT3 for each equipment.

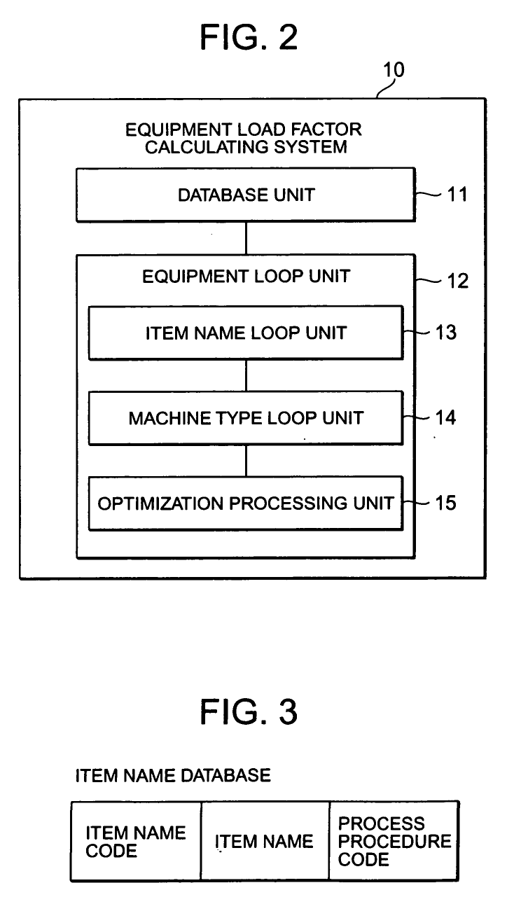

FIG. 2 is a block explanation diagram of the equipment load factor calculating system. In FIG. 2, the equipment load factor calculating system 10 constructed in the personal computer PC1 includes a database unit 11 and an equipment loop unit 12. The database unit 11 includes the item name database DB1, the process procedure database DB2, the equipment database DB3, the condition database DB4, the condition group database DB5, and the OEE database DB6. The equipment loop unit 12 includes an item name loop unit 13 and a machine type loop unit 14, and may further include an optimization processing unit 15. The item loop unit 13 executes an item name loop which will be described later. The machine type loop unit 1 executes a machine type loop which will be described later. The optimization processing unit 15 executes an optimization process which will be described later.

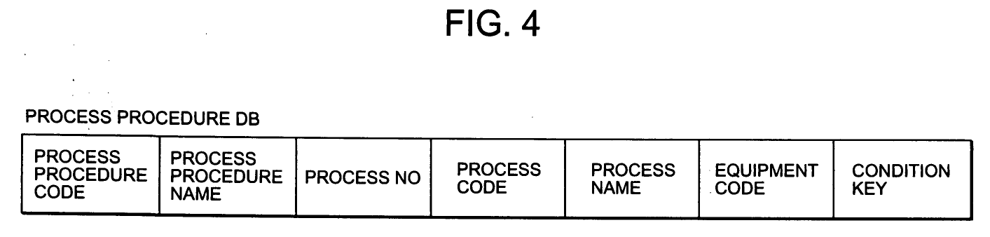

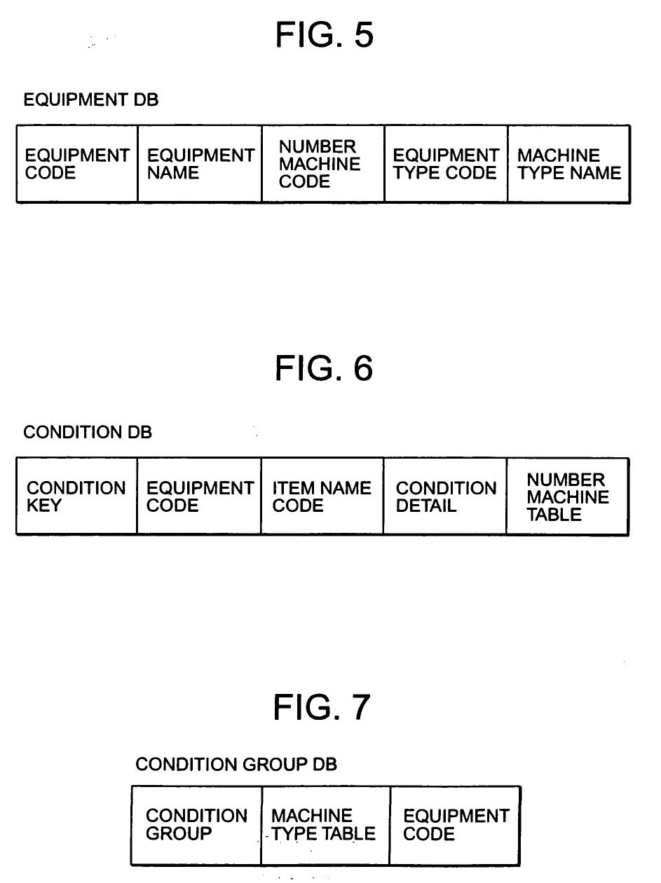

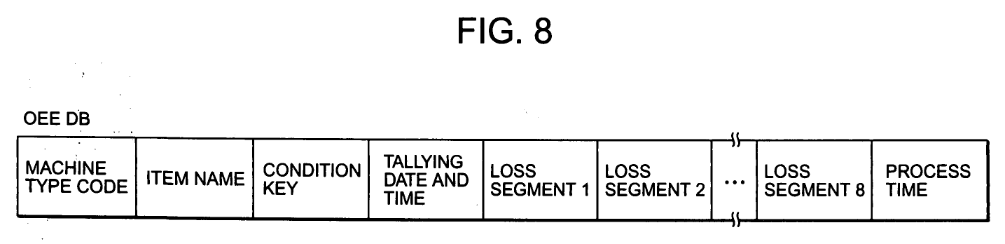

Now, a structure of each database will be described. FIG. 3 shows a specific example of a structure of the item name database. In FIG. 3, the item name database has fields of an item name code, an item name, and a process procedure code. FIG. 4 shows a specific example of a structure of the process procedure database. In FIG. 4, the process procedure database has fields of a process procedure code, a procedure name, a process NO, a process procedure code, a process name, an equipment code, and a condition key. FIG. 5 shows a specific example of a structure of the equipment database. In FIG. 5, the equipment database has fields of an equipment code, an equipment name, a number machine code, a machine type code, and a machine type name. FIG. 6 shows a specific example of a structure of the condition database. In FIG. 6, the condition database has fields of a condition key, an equipment code, an item name code, condition details, and a number machine table. FIG. 7 shows a specific example of a structure of the condition group database. In FIG. 7, the condition group database has fields of a condition group, a machine type table, and an equipment code. FIG. 8 shows a specific example of a structure of the OEE database. In FIG. 8, the OEE database has fields of a machine type code, an item name, a condition key, a tallying date and time, a loss segment 1, a loss segment 2, a loss segment 3, a loss segment 4, a loss segment 5, a loss segment 6, a loss segment 7 and a loss segment 8, and process time. The loss segments 1 to 8 respectively correspond to the planning maintenance loss, the failure loss, the changeover, the setup, the test time, the idle time, the speed loss, and the rework loss. In each field of the loss segments 1 to 8 and the process time, a theoretical value (second/work) is stored for the fixed OEE loss, and performance data (second/work) is stored for the fluctuating OEE loss and the process time. This performance data is obtained by using a different system that tallies each loss time (second/work) needed for processing of a single piece.

First, a process line in a semiconductor device production plant of the present exemplary embodiment will be described. In production of semiconductors, on the basis of a monthly loading plan, products are loaded, type of whose item names reach, for example, several hundred types. Products with such item names are each formed by a flow consisting of, for example, several hundreds of processes, and each process has a different manufacturing device and a manufacturing condition. Thus, combinations of item names and conditions to be tallied is, for example, several thousands to several tens of thousands, and loss time or process time for each segment are different from one case to another. Furthermore, since the loss time or process time for each segment also differs by a machine type, the number of combinations to be tallied is the number obtained by multiplying the number of combinations of item names and processes by the number of machine types. Here, a process is usually associated with a specific condition of one kind of manufacturing equipment.

In addition, typically, manufacturing equipment for implementing specific functions often has multiple machine types (two to ten machine types, for example) capable of implementing a same function, and furthermore, multiple number machine (two to dozens of units) usually belong to each machine type. In some cases, certain manufacturing equipment may implement more than one function. For example, manufacturing equipment capable of forming SiO2 film may also be capable of forming SiON film or SiN film. Consequently, the specific manufacturing equipment may be used not only in a same kind of process for multiple products but also in a same kind of specific item name process or in more than one process having different functions. In addition, it is possible to increase manufacturing equipment capable of performing a specific process, by planning and implementing provision of a condition even if they do not have a condition now. Since processable equipment and number machines differ for each item name and process, products should be allocated by considering the number of processable equipment for each process or process processing time for each machine type, when products are to be allocated among machine types. In equipment in this exemplary embodiment, for simplicity of the description, under one item name, condition keys shall differ in each process. Thus, the combinations of the item names and processes may be replaced by the combinations of item names and conditions and handled.

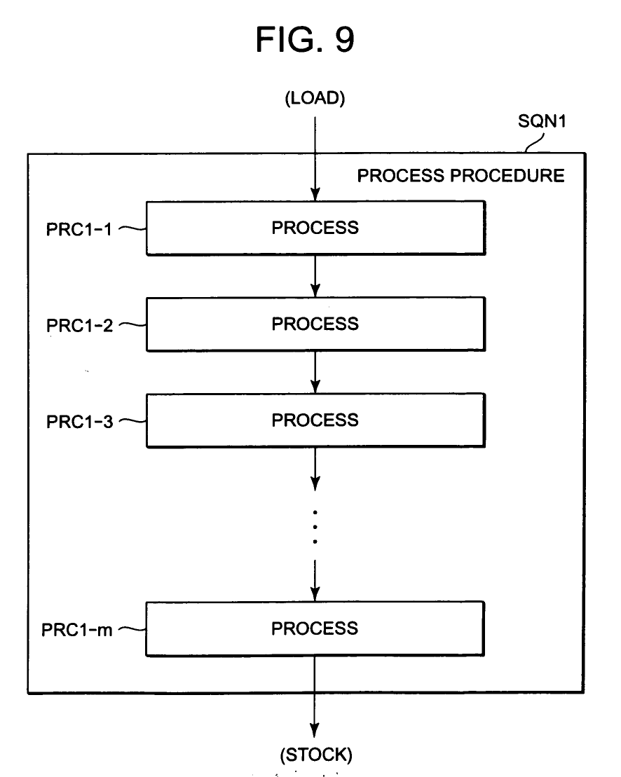

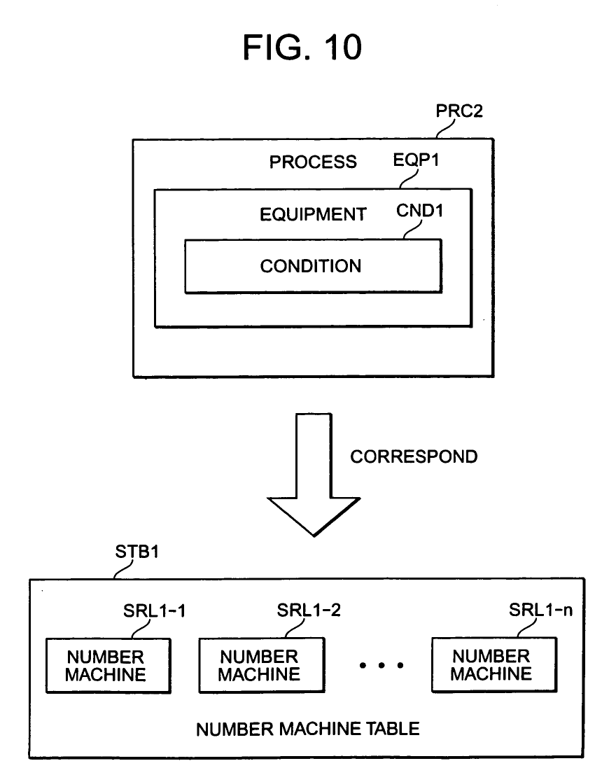

Now, a brief description will be given for data contained in the databases DB1 to DB6. FIG. 9 is a diagram explaining a process procedure. A procedure is defined for each item name, and describes all the processes of a wafer process necessary for producing a product. One kind of process procedure is associated with an item name. In FIG. 9, a process procedure SQN1 related to a certain item name consists of multiple processes PRC1-1, . . . , PRC1-m. The multiple processes PRC1-1, . . . , PRC1-m are ordered in a way that a product to be loaded is first processed and worked in the process RC1-1, then processed and worked in the process PRC1-2, and lastly processed and worked as well as stocked in the process PRC1-m. FIG. 10 is a diagram explaining the process. As illustrated, equipment EQP1 to be assigned to the process PRC2 is defined in the process PRC2. This equipment EQP1 may be assigned to more than one process. In order to assign the process PRC2, the equipment EQP1 is associated with a condition CND1. Although the equipment EQP1 can be operated under any of the multiple conditions, the equipment EQP1 will eventually be operated under the condition CND1 for the process PRC2. The equipment EQP1 has one or more machines (number machine). When the equipment EQP1 associated with the condition CND1 is defined, a combination of number machines to which the process PRC2 can be assigned, i.e., a number machine SRL1-1, a number machine SRL1-2, . . . , a number machine SRL1-n are defined. In FIG. 10, these number machines SRL1-1 to SRL1-n are indicated as a number machine table STB-1, collectively. In general, there are multiple machines to which a single process can be assigned. Specifically, examples of such equipment include an oxide dry etching device, a nitride dry etching device, and an tungsten dry etching device to each of which an equipment code is assigned. Examples of conditions include a program number, a prohibited position, standard time, allowable time, and each condition key is assigned according to combinations of the values of these conditions.

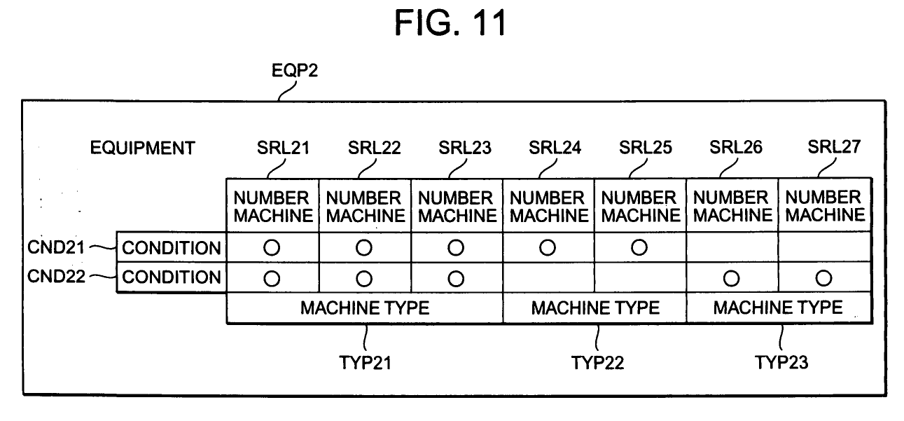

FIG. 11 is a view explaining a relationship among a condition, a number machine, and a machine type. In FIG. 11, equipment EQP2 can be operated under any of two conditions CND21 and 22. When the equipment EQP2 is operated under the condition CND21, it is possible to assign any of the number machines belonging to a corresponding number machine table (a number machine SRL21, a number machine SRL22, a number machine SRL23, a number machine SRL24, a number machine SRL25). When the equipment EQP2 is operated under the condition CND22, it is possible to assign any of the number machines belonging to a corresponding number machine table {a number machine SRL21, a number machine SRL22, a number machine SRL23, a number machine SRL26, a number machine SRL27}. Each of the number machines SRL21 to SRL27 is classified into a corresponding machine type. In FIG. 11, the number machine SRL21 to the number machine SRL23 belong to a machine type TYP21, the number machine SRL24 and the number machine SRL25 belong to a machine type TYP22, and the number machine SRL26 and the number machine SRL27 belong to a machine type TYP23. For example, a number machine is a unit of classification at an equivalent level to a machine's manufacturing number, whereas a machine type is a unit of classification at equivalent level to a machine's model number.

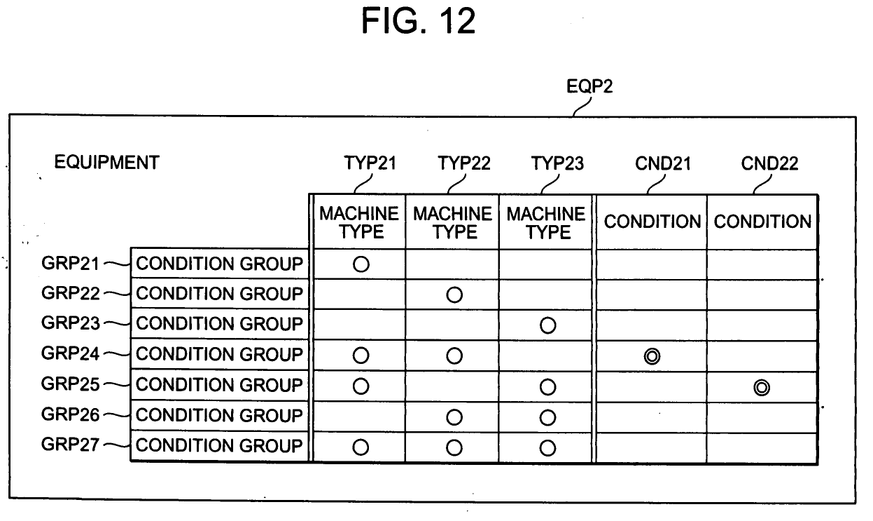

FIG. 12 is a diagram explaining a condition group. It is defined that each condition group indicates a combination of machine types. In FIG. 12, the equipment EQP2 has three different machine types TYP21 to TYP23, and therefore the equipment EQP2 may have seven condition groups. Specifically, the seven condition groups are a condition group GRP21 for the (machine type TYP21), a condition group GRP22 for the (machine type TYP22), a condition group GRP23 for the (machine type TYP23), a condition group for (the machine type TYP21, the machine type TYP22), a condition group GRP25 for (the machine type TYP21, the machine type TYP23), a condition group GRP26 for (the machine type TYP22, the machine type TYP23), and a condition group GRP 27 for (the machine type TYP21, the machine type TYP22, the machine type TYP23). However, as the equipment EQP2 can be operated under any one of the two conditions CND21 and CND22, consideration of only the condition group GRP 24 for the condition CND 21 and the condition group GRP25 for the condition CND22 suffices for calculating an equipment load factor.

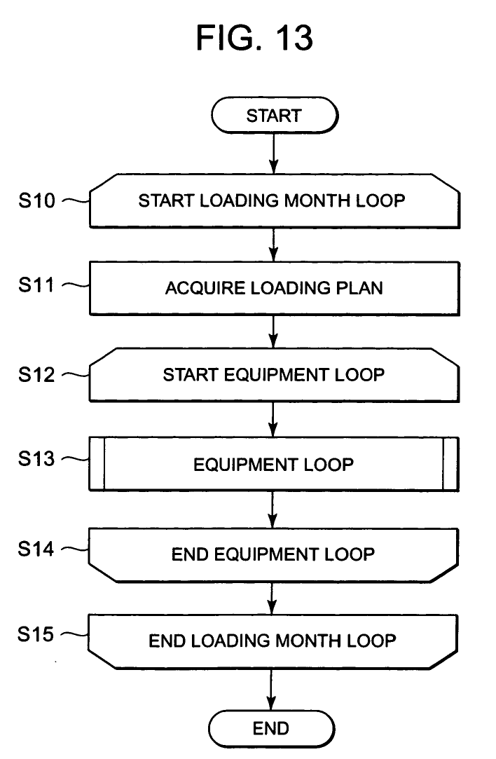

FIG. 13 is a flow chart of an equipment load factor calculating program executed in the equipment load factor calculating system. Here, a description will be given for a case in which verification is performed for more than one month, and thus an equipment load factor will be calculated for each loading month. As shown in FIG. 13, firstly, a loading month loop is started (S10), so as to repeatedly and sequentially process the loading months to be verified. For example, in order to verify a loading plan for three months of January, February, and March, processing in the step of starting the loading month loop (S10) to the step of terminating the loading month loop (S15) is repeated three times. In the loading month loop, a loading plan for each loading month (what and how many products are to be loaded) is acquired by reading a loading plan table file SHT1 (S11).

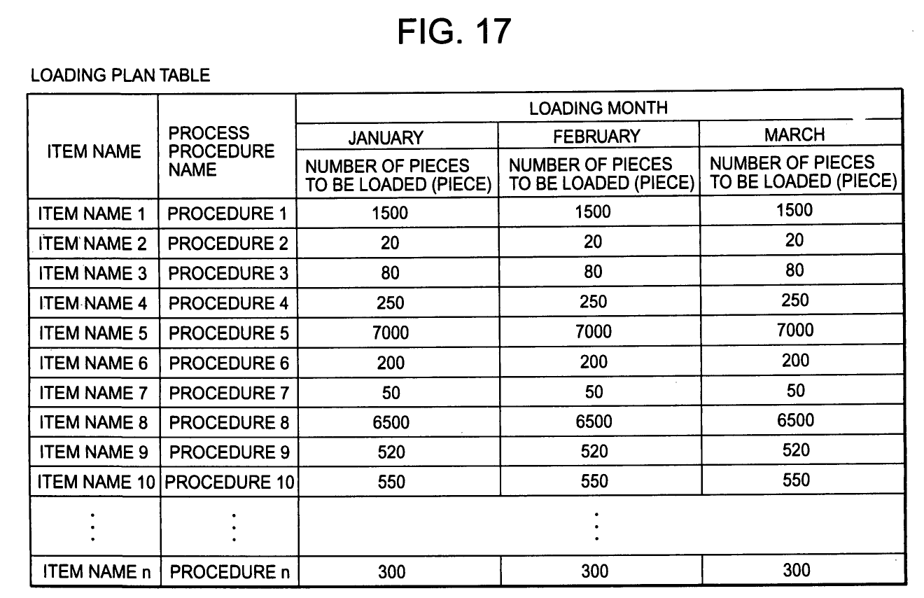

FIG. 17 shows a specific example of the loading plan table file. The loading plan table file is formed of spreadsheets of spreadsheet software, and is read by the equipment load factor calculating system. The loading plan table file in FIG. 17 has loading plans for three months of January, February, and March. In the loading plan table file, the number of pieces to be loaded is indicated for each item name formed of item name 1 to item name n. For example, the item name 1 represents a plan of loading 1,500 corresponding pieces for each month from January to March, and the item name 2 represents a plan of loading 20 corresponding pieces for each month from January to March.

Next, an equipment loop (sequentially repeated for all equipment to be verified) is started (S12) so as to verify a machine-type load factor among machine types for each equipment. The processing of the equipment loop (S13) is looped for all the equipment (S14), the equipment loop is further looped for all the loading months (S15). Thereby, equipment load factors for all the equipment are respectively calculated for all loading months.

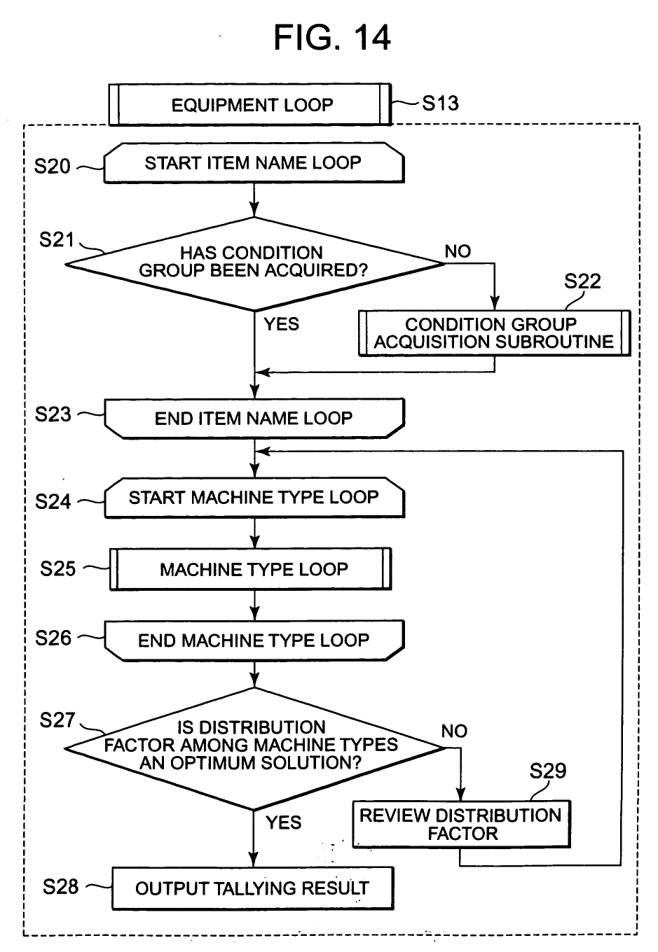

FIG. 14 shows a flow chart of the equipment loop. As shown in FIG. 14, in the equipment loop (S13), an item name loop (sequentially repeated for all the item names scheduled to be loaded) is started first (S20). Here, it is determined whether acquisition of condition group for currently-looped equipment and item name has completed (S21). If it has not been completed, then a condition group acquisition subroutine is executed for that equipment and item name (S22). All the item names are looped and the item name loop is terminated (S23). Thereafter, a machine type loop is started (S24), and is repeated for all the machine types belonging to the equipment currently being looped (S25). When the machine type loop for all the machine types is completed (S26), a machine-type load factor of each machine type is outputted.

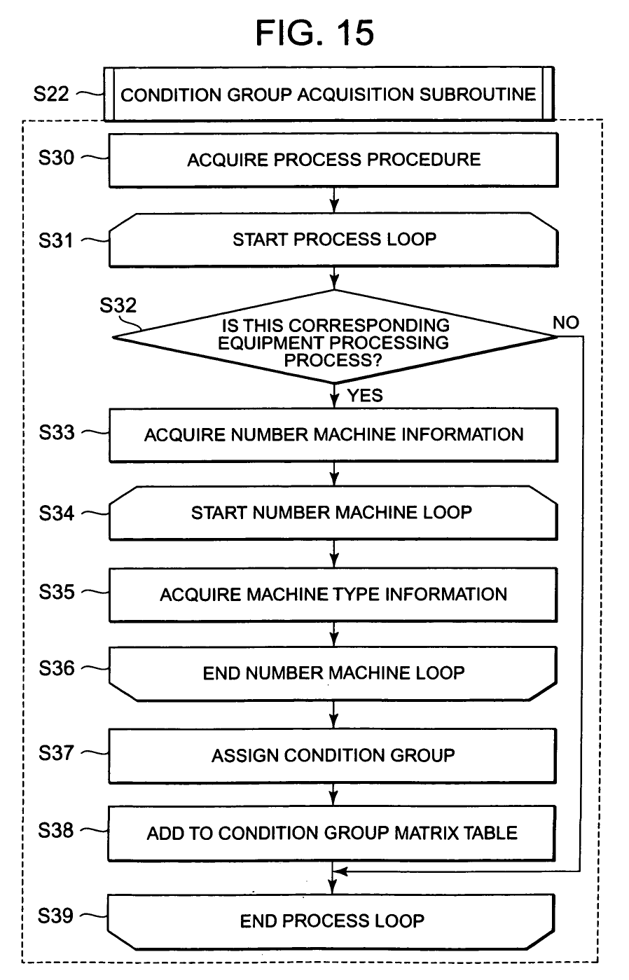

FIG. 15 shows a flow chart of the condition group subroutine. In the condition group acquisition subroutine (S22), acquires a process procedure code according to a target item name, from the item name database DB1 (S30). Next, a flow of a process (process flow) corresponding to the process procedure code is acquired from the process procedure database DB2, and a process loop (sequentially repeated for all the processes of the process procedure) is started (S31). Each process in the process procedures is sequentially checked from the loading process to the storing process, and a process to be executed by the target equipment is extracted (S32). If the process is a target process, then a number machine table is acquired from the condition database DB4 (S33). The number machine table stores the combinations of number machine codes capable of processing such process.

Next, a processable number machine is looped (S34). By acquiring a machine type code corresponding to a number machine from the equipment database DB3 (S35), the number machine code is associated with the machine type code. The number machine loop ends (S36). Subsequently, using the acquired processable number machine table and the condition group database DB5, a corresponding condition group is acquired, and is assigned (S37). In a condition group matrix table spreadsheet, the condition group is added to a column defined by the item name and condition key (S38). This flow is looped for all the processes, and the condition group acquisition subroutine ends (S39).

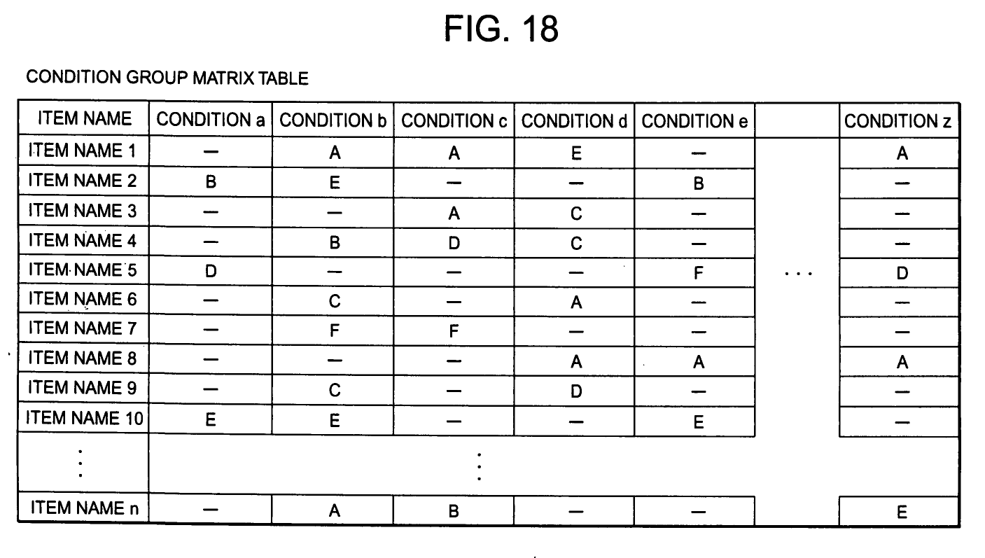

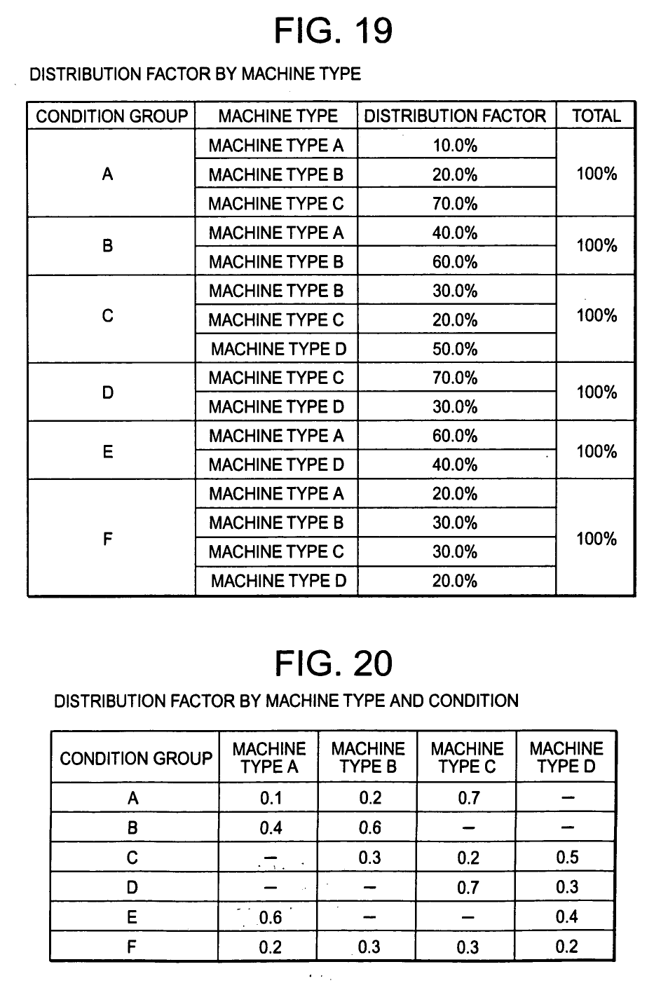

FIG. 18 shows a specific example of the condition group matrix table spreadsheet. This condition group matrix table spreadsheet is prepared for each equipment. The condition group matrix table spreadsheet is created for when using it for the first time, and is updated for the second time or later. The update is performed, for example, when a loaded item name is new data that has never been stored before. In FIG. 18, lower-case alphabet letters in a condition a, a condition b, . . . , a condition z are keys, and the condition a, the condition b, . . . , and the condition z represent condition keys being different to each other. As described above, in the present exemplary embodiment, descriptions are given for the case in which a single item name has a different condition key for each process, and thus each process can be uniquely defined by use of the item name and the condition key. In addition, as described in FIG. 12, a single exclusive condition group can be assigned to each process. In FIG. 18, condition groups each representing a combination of machine types are entered in columns at which the corresponding item name and the corresponding condition key intersect. FIG. 19 shows specific contents of the condition group A to the condition group F in FIG. 18.

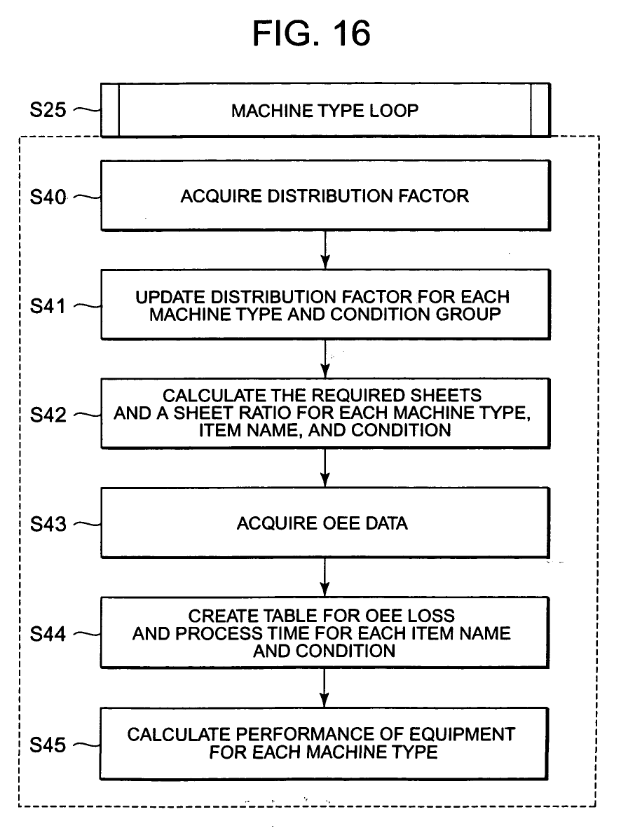

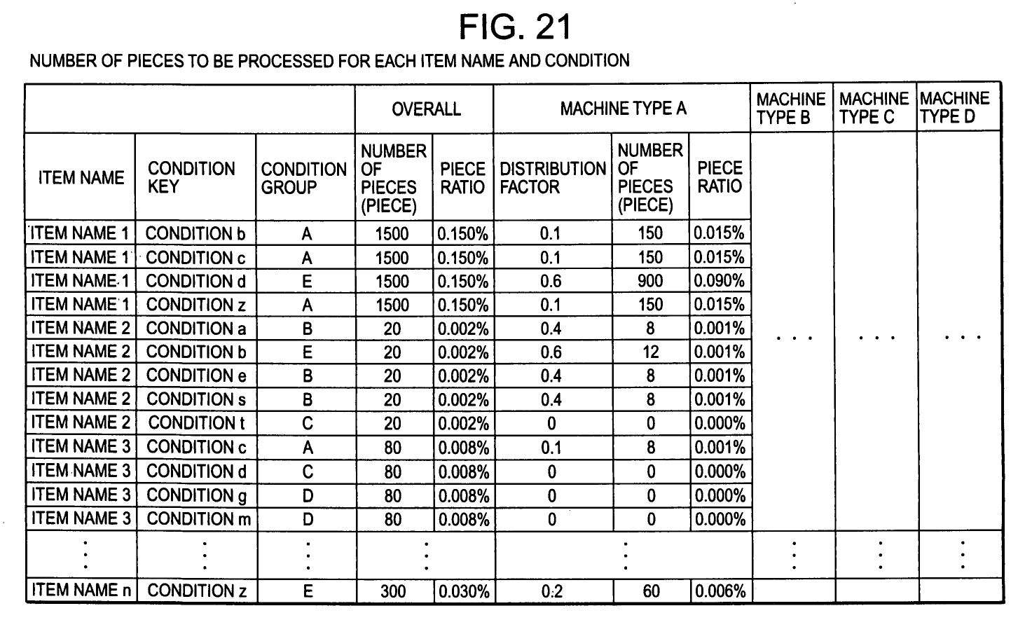

FIG. 16 shows a flow chart of the machine type loop. In FIG. 16, first, distribution factor data shown by the machine types and the condition groups from the distribution factor table spreadsheet for each machine type (S40), the condition groups being currently assigned, the distribution factor table spreadsheet being specifically exemplified in FIG. 19. Then, as specifically shown for example in FIG. 20, the distribution factor table spread by machine type and condition group is updated (S41). As apparent from FIG. 20, the equipment here has four machine types of machine type A to machine type D. According to the distribution factor data in the distribution factor table spreadsheet by machine type and condition group, the number of pieces to be processed as well as a ratio of such number of pieces are calculated for each item name and condition (S42). In addition, a spreadsheet of a table for the number of pieces to be processed is created for each item name and condition, as specifically shown for example in FIG. 21. In the spread sheet of a table for the number of pieces to be processed for each item name and condition of FIG. 21, the data in the item name, condition key and condition group columns are data acquired from the condition group matrix table spreadsheet of FIG. 18. The data in the overall column has been prepared based on the data of January in the loading plan table file of FIG. 17. Assuming that 1 million pieces are loaded in January, the ratio of the number of pieces to be processed is calculated up to the three places of decimals, and rounding it off at the fourth decimal place. The data in the columns for the machine type A to the machine type D are created from the data in the distribution factor table spreadsheet by machine type and condition group of FIG. 20.

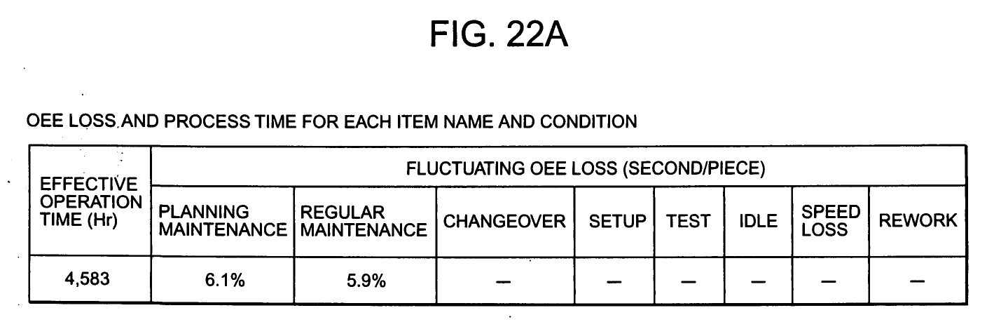

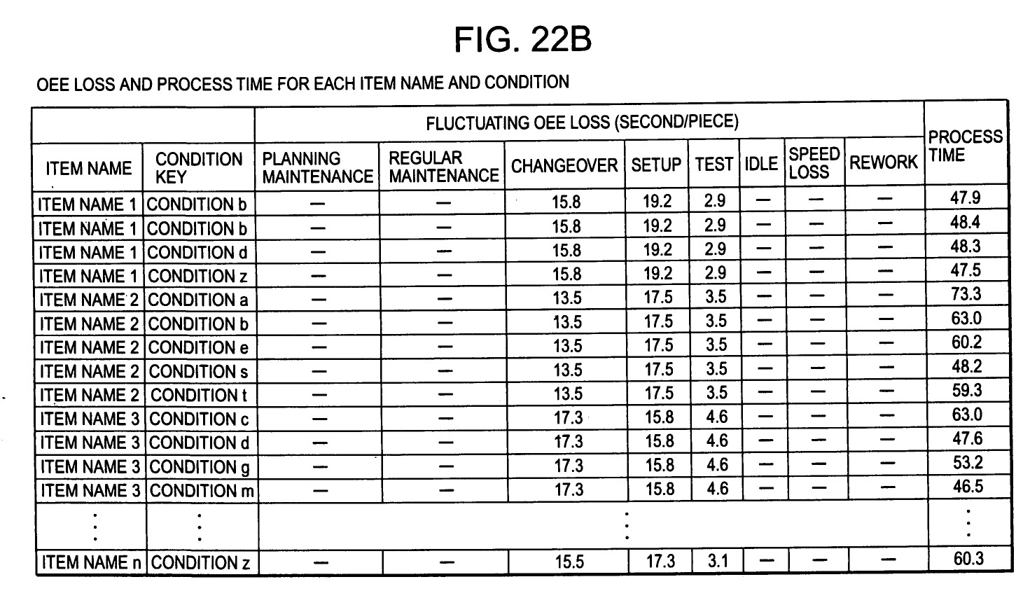

In the flow chart of the machine type loop shown in FIG. 16, for each machine type, eight-segmented loss time data and process time data are acquired for each item name and condition key from the OEE database DB6 (S43). Subsequently, by tallying effective operation time obtained by multiplying a value obtained by subtracting the fixed OEE loss from the operating days, by the number of units of the target machine type; the fixed OEE loss; the fluctuating OEE loss per piece for item name and condition; and process time, a listing table spreadsheet of the OEE loss and the process time is created for each item name and condition, as specifically shown for examples in FIG. 22A and FIG. 22B, (S44). This listing table spreadsheet is created for each equipment and for each machine type. FIG. 22A shows a listing table spreadsheet according to the fixed OEE loss of the machine type A. In FIG. 22A, the effective operation time is calculated by an expression where ‘Number of operating days×24 (Hour)×{1−Fixed OEE loss ratio}×number of units.’ In FIG. 22A, the number of operating days in January is 31 days, and the number of number machines belonging to the machine type A is 7 units, thus it is calculated by 31×24×{1−0.0610−0.059}×7≈4.583 (Hour). FIG. 22B shows a listing spreadsheet related to the fluctuating OEE loss and the process time of the equipment A. Since the fluctuating OEE loss and the process time vary with an increase and decrease in number of processed pieces, they are both expressed by a unit of second/work.

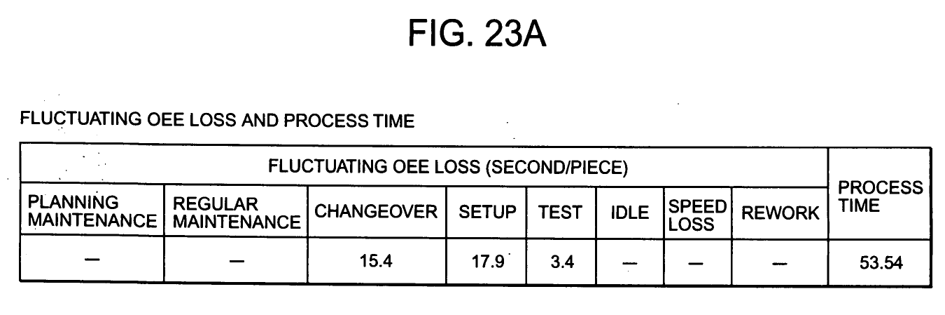

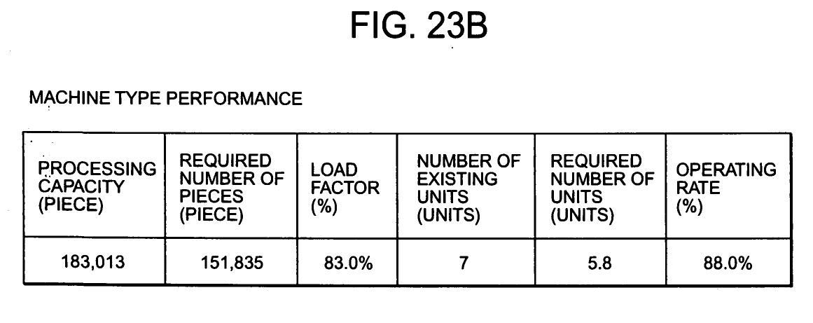

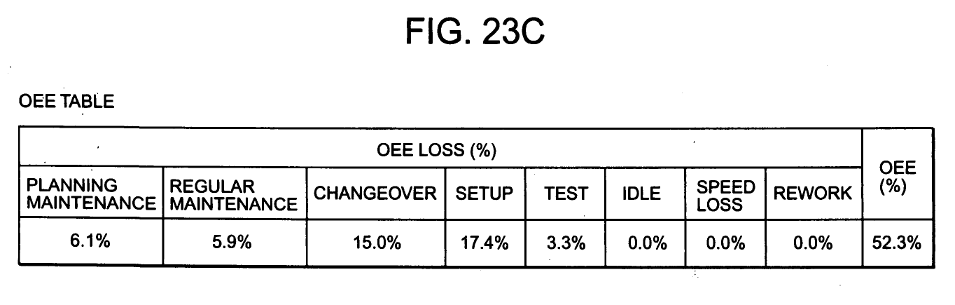

In the flow chart of the machine type loop shown in FIG. 16, the equipment performance is calculated for each machine type (S45), and the fluctuating OEE loss and process time, the machine type performance, and the OEE table are tallied for each machine type. As specifically shown for example in FIG. 23A to FIG. 23C, a capacity tallying table spread sheet is created for each machine type. FIG. 23A is the result of tallying the listing table spreadsheet of FIG. 22B, and the fluctuating OEE loss and the process time are figured out by calculating a weighted average. FIG. 23B is the result of tallying machine type performance of the machine type A. In FIG. 23B, the processing capacity is the processable number of pieces when all the number machines belonging to the machine type A is fully operated only during the effective operation time, and is calculated by effective operation time×60 (minutes)×60 (seconds)/(time necessary per piece). However, the time necessary per piece is {process time necessary for processing one piece+Σ fluctuating OEE loss time}. The number of products to be processed is a total number of pieces in the columns for the machine type A in FIG. 21. The machine-type load factors are calculated by {number of pieces to be processed/processing capacity}. The existing number of units is the number of units of the number machines that belong to the machine type A. The number of necessary units is calculated by {existing number of units×machine-type load factor}. The operating rate is calculated by {1−fixed OEE loss}. FIG. 23C expresses the fluctuating OEE loss and the process time of FIG. 23A in percent figures. The changeover (%) is calculated by changeover (second/work)×{1−Fixed OEE loss (%)}/{fluctuating OEE loss (second/work)+process time (seconds/work)}. The setup (%) is calculated by setup (second/work)×{1−fixed OEE loss (%)}/{fluctuating OEE loss (second/work)+process time (second/work)}. The test time (%) is calculated by test time (second/work)×{1−Fixed OEE loss (%)}/{fluctuating OEE loss (second/work)+process time (seconds/work)}. The obtained tally results are outputted to a predetermined sheet of capacity verification file.

In the equipment loop shown in FIG. 14, when the machine type loop ends (S26), the machine-type load factors for all the machine types are compared, and the optimization processing of the distribution factor is performed (S27, S28). The optimization processing needs to be performed while considering which number machine is a processable number machine for each process and also considering the difference in the process processing time among the machine types. However, it is extremely difficult to manually determine what piece to assign from what machine type to what machine type in what portion, in order to equalize the load factors among machine types. To solve this, a solver (nonlinear optimization analysis program) is used in the optimization processing.

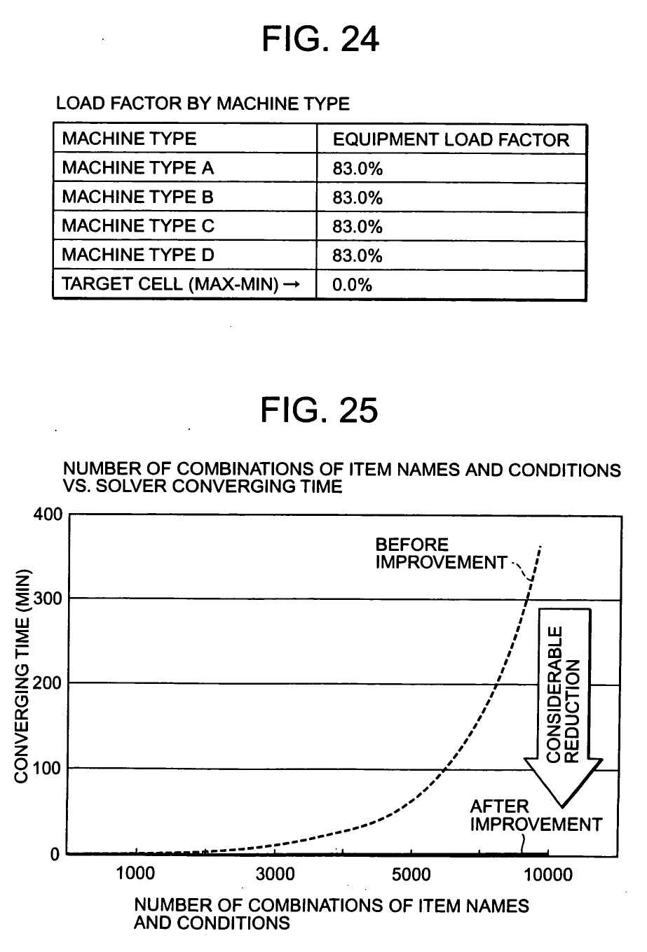

A machine-type load factor for each machine type can be referred by creating a machine-type load factor table spreadsheet by machine type. FIG. 24 is a view showing a specific example of the machine-type load factor table spreadsheet by machine type, in which a value obtained by subtracting a MIN value from a MAX value of the machine-type load factors among machine types is shown in a target cell. In solver processing, a cell to be changed and constraint conditions are set. Then, iterative calculation is performed when all the constraint conditions are satisfied and when the target cell (MAX−MIX) is smallest (i.e., a difference of machine-type load factors among machine types is the smallest) concerning that it is an optimum solution. To be more precise, all the combinations of existing machine types and condition groups are figured out and cells to be assigned to respective machine types in respective condition groups are set as the cells for changing distribution factors. The constraint conditions are set so that the distribution factor of each machine type is not smaller than 0% but not larger than 100%, and that a total of the distribution factors of the respective condition groups becomes 100%.

During the solver processing, according to an optimization analysis algorithm, a value of the distribution factor in the cell set as the cell to be changed, varies so that the target cell approaches the smallest value (S29). Based on this change in the distribution factor, the number of pieces to be processed and the machine-type load factor for each machine type are recalculated (S25). By repeatedly checking the distribution factors by the solver, iterative calculations are performed so that the target cell approaches the smallest value, and thus an optimum solution of the distribution factor can be figured out. The load factor when the solver converges in this manner becomes a final machine-type load factor for each machine type and outputted as tally result (S28).

The present exemplary embodiment is a scheme to acquire by the solver an optimal distribution factor among machine types capable of processing a same process, and to allocate, according to the thus acquired distribution factor, the number of pieces to be loaded in a certain period of time. Thus, a load factor can be calculated with high precision in only one calculation, while equalizing machine-type load factors among the machine types as much as possible within one equipment. For example, if there are about 100 kinds of equipment groups (combinations of machine types that process a same process), then iterative calculations for calculating a load factor is 1×about 100 times for all the equipment. In contrast, in Patent Document 1, since the calculation is needed for each equipment about 30 million times, the iterative calculation for a load factor is 30 million×about 100 times. In addition, as it is assumed that the exemplary embodiment in Patent Document 1 describes only one equipment group, to tally for the overall equipment, calculations must be repeated as much as the number of equipment groups, as in this exemplary embodiment. Thus, the number of iterative processing related to the load factor calculation in this exemplary embodiment is about 1/30 million in the case of Patent Document 1, and it can be observed that recalculation at the time of changing a loading plan will be simple and done in a short period of time.

A supplementary explanation will be given to the solver. As calculation of the equipment load factor needs a vast amount of data, and as the number of machine types increases, computation expressions become more complicated and large accordingly. As data amount will be approximately equal to the number of combinations of machine types and conditions×the number of combinations of machine types (the number of segments×the number of machine types: about 100 kinds, for example), the number will be several thousand to several million if the number of combinations of machine types and conditions is thousands to some tens of thousands. For this reason, recalculation of all the expression cells in the iterative calculations would be too time-consuming, if computation expressions, which are combinations of functions or cell references, are set for all the cells, as in the case of the solver processing used in general. Even though the solver is used, it takes huge amount of time for the solver to converge, and it is far from a level of practical use. Hence, the solver converging time is substantially shortened, in addition to the two improvements as described below.
[1] A program is added so that all of the cells that are not recalculated even when a value of a cell to be changed by iterative calculations of the solver, are tallied in advance. Furthermore, the program is added so that data needed for simplifying the expressions are tallied in advance.
[2] Since the number of item names or conditions changes depending on a loading month, it is desirable to ensure as many rows and columns the item name and condition keys in a condition group matrix table spreadsheet, a required number of sheets table spreadsheet for each item name and condition, and an OEE loss and process time listing table spreadsheet for each item name and condition as a maximum value assumed for item names and condition keys. Thus, each table spreadsheet has been created such that it allows more than the actual number of item name and condition keys. Before the improvement, mathematical expressions are entered even in the spare cells that are thus a target of recalculation. Hence, a program is added that acquires information on item names to be actually loaded and actually necessary condition keys from item names and process procedures scheduled to be loaded in a verifying month and that automatically erase all of mathematical expressions of unnecessary cells.

For example, there are provided multiple sheets for the spreadsheet of the number of pieces to be processed for each item name and condition of FIG. 21, the OEE loss time and process time listing table spreadsheets for each item name and condition of FIG. 22A and FIG. 22B, and the machine type capacity tallying table spreadsheet of FIG. 23A to FIG. 23C have a multiplicity of cells. Here, advance tallying of cells not to be recalculated during optimization processing of the distribution factors among machine types and minimization of computation expression cells are carried out. To be more precise, in the spreadsheet of the number of pieces to be processed for each item name and condition of FIG. 21, advance tallying is carried out in the columns respectively for the item name, the condition key, the condition group, the total piece number, and the total piece ratio; and mathematical expressions is set in the cells in the columns for the distribution factor, the number of pieces, and the piece ratio for each cell. The spreadsheet is designed in a way that, when the distribution factor varies, only cells for which mathematical expressions are set will be automatically recalculated. In addition, for spare cells in which actually no item name and conditions keys have been included, all mathematical expressions are automatically removed, thereby preventing useless calculations during recalculation (minimization of mathematical expression cells). In addition, in the OEE loss and process time listing table spreadsheet for each item name and condition of FIG. 22A and FIG. 22B, all the data is tallied in advance. This considerably reduces time necessary for the solver to converge. In addition, also in the machine type capacity tallying table spreadsheet of FIG. 23A to FIG. 23C, cells whose values do not change during optimization processing are tallied in advance, and mathematical expressions are set only for cells to change.

By these improvements, in other words, by adding the programs of [1] and [2], the number of cells to be recalculated is reduced considerably, and mathematical expressions in the cells to be recalculated is simplified, thereby substantially shortening the time for the solver to converge. For example, if the number of combinations of item names and conditions is set to 10000 cases in equipment, then the number of mathematical expression cells is reduced to about 100-thousand cases compared to 1 million cases before the improvement. The mathematical expressions are further simplified by performing complicated tallying in advance as much as possible by the programs. FIG. 25 is a graph showing a relationship between the number of combinations of item names and conditions, and the solver converging time. As illustrated, the solver converging time takes 6 hours or longer before the improvements, whereas the solver converging time is reduced down to approximately 1 minute after the improvements.

Now, a description will be given for the load factor calculation incorporating an improvement plan of equipment. In the present exemplary embodiment, as shown in FIG. 22A to FIG. 23C, the loss time or process time is tallied for each item name and process. Further, the machine-type load factor is calculated for each machine type by optimizing the distribution factor, and hence capacity verification that allows for improvement effect of loss reduction is possible for each loss segment. If reduction of the loss time is scheduled before the processing of pieces, then tallying should be performed with the loss time including that data. For example, for each machine type, data showing a relationship among a scheduled processing date and time of each process, an improvement effect and an expecting degree of each segment, and an improvement effect contributing period, is created by use of a different system. Then, the data is, for example, read by the equipment load factor calculating system of the present exemplary embodiment.

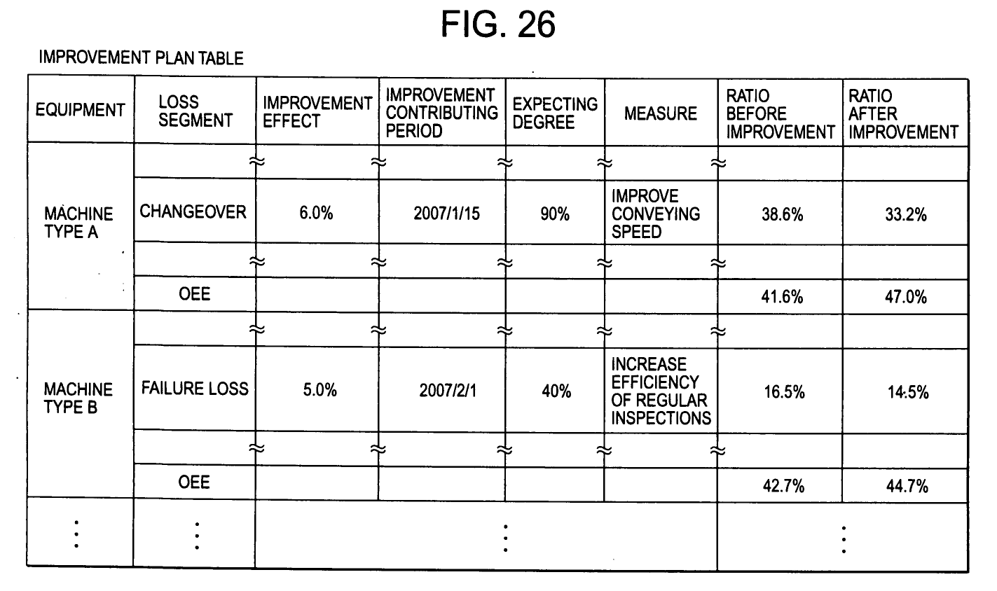

FIG. 26 shows a specific example of an improvement plan table file. This improvement plan table file, formed of spreadsheets of spreadsheet software, shows a loss segment for each machine type, improvement effect that can be theoretically expected, effect contributing period, expecting degree, measure, and a ratio for each segment before and after improvement, with respect to a machine type belonging to equipment for which improvement activity is conducted or planned. The expecting degree is a value determined based on the feasibility of the improvement or the certainty of the effect contributing period, etc. and becomes 100% when the improvement can be reliably realized. In addition, “OEE” in the loss segment column represents a percentage of the process time. In this exemplary embodiment, the improvement plan of the improvement plan table file as shown in FIG. 26 is reflected in the loss time for each segment stored in the OEE database DB6. This reflection processing is performed in the course of creation of the OEE loss and process time listing table spreadsheet for each item name and condition of FIG. 22A and FIG. 22B. With this, improvement effect is automatically incorporated.

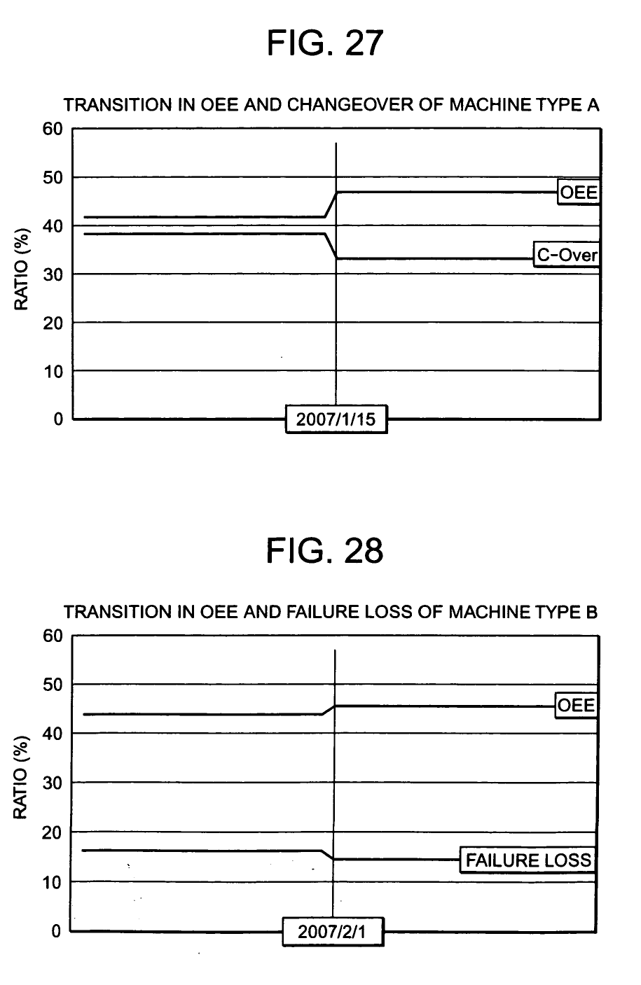

As shown in FIG. 26, there is an improvement plan in which the machine type A can reduce the changeover by 6% by improving a conveying speed, and this effect can be expected from Jan. 15, 2002. As the expecting degree is 90%, the changeover can be reduced only by 6%×90%=5.4% from Jan. 15, 2007, which in turn increases the percentage of the process time (OEE) by 5.4%. As shown in FIG. 27, after Jan. 15, 2007, the changeover is lowered from 38.6% to 33.2%. In addition, the process time is increased from 41.6% to 47.0%. Thus, for a loading plan of the machine type A after Jan. 15, 2007, the capacity verification is performed by using the numeric values after this improvement.

In addition, there is an improvement plan for the machine type B in which failure loss can be reduced by 5% by increasing the efficiency of regular inspections and that effect can be expected from Feb. 1, 2007. Since the expecting degree is 40%, the failure loss can be reduced only by 5%×40%=2.0% from Feb. 1, 2007, which in turn increases the percentage of the process time (OEE) by 2.0%. As shown in FIG. 28, after Feb. 1, 2007, the failure loss is lowered from 16.5% to 14.5%. In addition, the process time is increased from 42.7% to 44.7%. Thus, for a loading plan of the machine type B after Feb. 1, 2007, capacity verification is performed by using the numeric values after this improvement.

Note that, in the above description, a wafer is assumed as an item name, and thus the unit of counting is expressed as piece. Nonetheless, this exemplary embodiment can target various products and goods to be loaded into a process line. When piece is referred to in this application, it is not limited to the unit of counting of wafer, but it shall also include the unit of counting that counts various products and goods other than wafer.

As described above, according to the present exemplary embodiment, as the number of required pieces can be calculated for each process (item names×conditions), a machine-type load factor among machine types can be equalized even when there is equipment that can be assigned to more than one process. In addition, the solver processes processing (S24 to S27, S29) for obtaining an optimal distribution factor among machine types, the number of calculations can be reduced considerably. Then, as the by-segment loss time and process time are calculated for each machine type, the loss time reduction activity being conducted on a daily basis can be reflected. In addition, as products can be distributed in terms of one piece depending on the distribution factor for each machine type, an error in equalization of the machine-type load factor due to bias in the number of products to be processed can be kept in a range of one piece, as far as there is not a considerable bias in the number of number machines or processable processes among machine types. A manager can thus make a correct determination dramatically on whether or not to load or whether or not equipment investment is needed.

Further, it is noted that Applicant's intent is to encompass equivalents of all claim elements, even if amended later during prosecution.

What is claimed is:

1. An equipment load factor calculating system, comprising:
a database unit; and
an equipment loop unit,
wherein the database unit includes:
an item name database to be searched for, by an item name, a process procedure of the item name;
a process procedure database to be searched for, by a process procedure, a process included in the process procedure, and to be searched for, by a process, equipment to which the process is assigned and a condition to be given to the equipment;
an equipment database to be searched for, by equipment and a number machine included in the equipment, a machine type of the number machine,
a condition database to be searched for, by an item name, equipment to which a piece corresponding to the item name is loaded, and a condition given to the equipment, a number machine table formed of a combination of number machines operable under the condition; and
a condition group database to be searched for, by a combination of equipment and a machine type included in the equipment, a condition group representing a combination of machine types, and
wherein the equipment loop unit includes:
an item name loop unit configured to
extract, for certain equipment, a process to be assigned to the equipment and a condition of the process, by referring to the item name database and the process procedure database,
acquire a number machine table for each extracted process, by referring to the condition database, and
acquire, from the number machine table, a condition group for the each extracted process, by referring to the equipment database and the condition group database; and
a machine-type loop unit configured to
acquire, for each of condition groups, distribution factor data for each of machine types included in the corresponding condition group,
obtain, for each process, data of a required number of pieces to be processed by process and machine type, based on the distribution factor data, the data being data to be assigned to each machine type,
tally, for each machine type, the data of the number of pieces to be processed, and
acquire machine-type load factor data for each machine type.

2. The equipment load factor calculating system according to claim 1, wherein the equipment loop unit further includes an optimization processing unit that acquires such distribution factor data that the machine-type load factor data for each machine type are equalized among machine types.

3. The equipment load factor calculating system according to claim 2, wherein the optimization processing unit executes a solver for acquiring distribution factor data making closest to zero a difference between a maximum value and a minimum value in the machine-type load factor data for each machine type.

4. The equipment load factor calculating system according to claim 3, wherein the optimization processing unit, before executing the solver, executes a program of erasing a mathematical expression in a cell not to be recalculated even when the solver is executed.

5. The equipment load factor calculating system according to claim 4, wherein
the database unit further includes an OEE (Overall Equipment Efficiency) database to be searched for loss time and process time per item name, for each of processes and for each machine type to be assigned to the corresponding process; and
the machine-type loop unit is further configured to
acquire, for each machine type and process, loss time data and process time data per item name, by referring to the OEE database,
tally, for each machine type, loss time data and process time data of all the processes, and
acquire, for each machine type, the loss time data and the process time data for every piece per item name.

6. The equipment load factor calculating system according to claim 5, wherein the OEE database includes
as a loss segment of the loss time, a loss segment of fixed loss time independent of the number of item names, and
a loss segment of fluctuating loss time dependent on the number of item names, wherein
the loss segment of the fixed loss time includes
a loss segment for planning maintenance loss time, and,
a loss segment for failure loss time, and
the loss segment of the fluctuating loss time includes
a loss segment for changeover loss time,
a loss segment for setup loss time,
a loss segment for test time loss time,
a loss segment for idle time loss time,
a loss segment for speed loss time, and
a loss segment for rework loss time.

7. The equipment load factor calculating system according to claim 6, wherein the machine-type loop unit is further configured to
input an improvement plan list file that includes improvement data indicating an improvement plan for each loss segment, and
make a correction, by use of the improvement data, on loss time data obtained from the OEE database.

8. An equipment load factor calculating program product storing a program causing a computer to execute, comprising:
extracting a process to be assigned to certain equipment;
figuring out, for each process, a condition group representing a combination of assignable machine types;
determining, for each machine type, distribution factor data for each condition group;
calculating, for each process, a required number of pieces to be processed by process and machine type, according to the distribution factor data, the number of pieces being a number of pieces to be assigned to each machine type; and
calculating a machine-type load factor for each machine type belonging to the equipment, on the basis of the required number of pieces to be processed by processes and machine type.

9. An equipment load factor calculating method causing a computer to execute, comprising:
extracting from databases a process to be assigned to certain equipment;
determining, for each process, a condition group representing a combination of assignable machine types;
acquiring, for each machine type, distribution factor data for each condition group;
calculating, for each process, the required number of pieces to be processed by process and machine type, according to the distribution factor data, the required number of pieces being a number of pieces to be assigned to each machine type; and
calculating a machine-type load factor for each machine type belonging to the equipment, on the basis of the required number of pieces to be processed by process and machine type.
